(19) United States
(12) Patent Application Publication
(10) Pub. No.: US 2016/0281517 A1
(43) Pub. Date: Sep. 29, 2016

(54) CAST NOZZLE WITH SPLIT AIRFOIL

(71) Applicant: Solar Turbines Incorporated, San Diego, CA (US)

(72) Inventors: Yong Weon Kim, San Diego, CA (US); Garrett P. Prins, San Diego, CA (US)

(73) Assignee: Solar Turbines Incorporated, San Diego, CA (US)

(21) Appl. No.: 14/669,902

(22) Filed: Mar. 26, 2015

(51) Int. Cl. F01D 9/04; F01D 25/12

(52) U.S. Cl. CPC F01D 9/041; F01D 25/12; F05D 2220/32; F05D 2240/128; F05D 2260/202; F05D 2240/123; F05D 2240/124

(57) ABSTRACT

A nozzle segment for a turbine nozzle of a gas turbine engine is disclosed. The nozzle segment includes an upper endwall, a lower endwall spaced apart from the upper endwall, a pressure portion, and a suction portion. The pressure portion extends between the upper endwall and the lower endwall adjacent a first side of the nozzle segment. The suction portion is spaced apart from the pressure portion and extends between the upper endwall and the lower endwall adjacent a second side of the nozzle segment. The second side is opposite the first side.

### TECHNICAL FIELD

The present disclosure generally pertains to gas turbine engines, and is directed toward a cast nozzle segment with a split airfoil.

### BACKGROUND

Gas turbine engines include compressor, combustor, and turbine sections. The turbine section is subject to high temperatures. The nozzle segments are often cooled with air from the compressor directed through various passageways and cooling holes. These passageways and cooling holes can be difficult to manufacture and may be geometrically limited due to the casting process.

U.S. Pat. No. 7,316,539 to C. Campbell discloses a vane assembly formed by a forward airfoil segment and an aft airfoil segment. The aft segment is made of metal and can define the trailing edge of the vane assembly. The forward segment can be made of ceramic, CMC or metal. The forward and aft segments cannot be directly joined to each other because of differences in their rates of thermal expansion and contraction. The forward and aft segments can be positioned substantially proximate to each other so as to form a gap there between. In one embodiment, the gap can be substantially sealed by providing a coupling insert or leaf springs in the gap. A separate metal aft segment can take advantage of the beneficial thermal properties of the metal to improve cooling efficiency at the trailing edge without limiting the rest of the vane being made out of metal.

The present disclosure is directed toward overcoming one or more of the problems discovered by the inventors or that is known in the art.

### SUMMARY OF THE DISCLOSURE

A nozzle segment for a turbine nozzle of a gas turbine engine is disclosed. In embodiments, the nozzle segment includes an upper endwall, a lower endwall spaced apart from the upper endwall, a pressure portion, and a suction portion. The pressure portion extends between the upper endwall and the lower endwall adjacent a first side of the nozzle segment. The suction portion is spaced apart from the pressure portion and extends between the upper endwall and the lower endwall adjacent a second side of the nozzle segment. The second side is opposite the first side. When installed in a gas turbine engine, the pressure portion of a first nozzle segment and the suction portion of a second nozzle segment form an airfoil.

### BRIEF DESCRIPTION OF THE DRAWINGS

FIG. 1 is a schematic illustration of an exemplary gas turbine engine.

FIG. 2 is a perspective view of a nozzle segment for the gas turbine engine of FIG. 1.

FIG. 3 is a perspective view of a nozzle segment of FIG. 1 with a cooling insert.

FIG. 4 is a cross-sectional view of two adjacent nozzle segments for the gas turbine engine of FIG. 1.

FIG. 5 is a cross-sectional view of a portion of adjacent nozzle segments illustrating an alternate embodiment of the leading edge of the airfoil formed by the adjacent nozzle segments of FIG. 4.

FIG. 6 is a cross-sectional view of a portion of adjacent nozzle segments illustrating another alternate embodiment of the leading edge of the airfoil formed by the adjacent nozzle segments of FIG. 4.

FIG. 7 is a cross-sectional view of a portion of adjacent nozzle segments illustrating an alternate embodiment of the trailing edge of the adjacent nozzle segments of FIG. 4.

### DETAILED DESCRIPTION

The systems and methods disclosed herein include a nozzle ring of a gas turbine engine. The nozzle ring includes split airfoils formed by adjacent nozzle segments. In embodiments, each nozzle segment includes an upper endwall, a lower endwall, and two airfoils portions extending there between. Each airfoil portion is located on a side of the nozzle segment and forms an airfoil with an airfoil portion of an adjacent nozzle segment. The airfoils generally include cooling cavities. By splitting each airfoil into at least two parts and onto two nozzle segments, the difficulties of manufacturing airfoils with enclosed cavities can be avoided, which may reduce manufacturing costs. For example, the nozzle segments can be manufactured without core-dies to form the airfoil cavities.

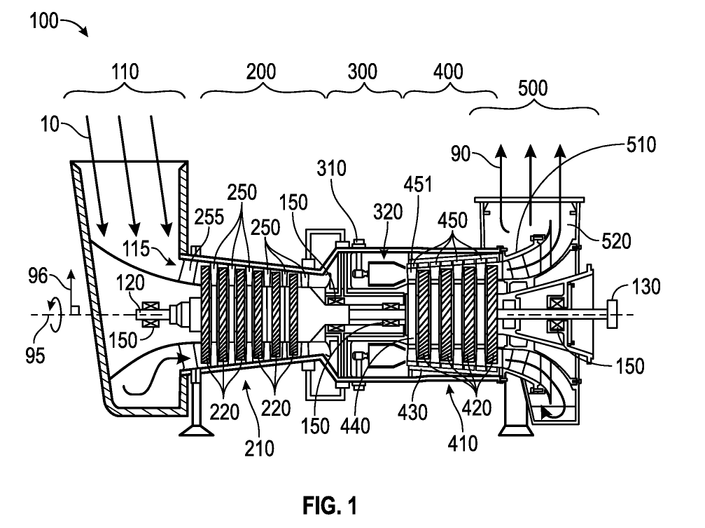

FIG. 1 is a schematic illustration of an exemplary gas turbine engine. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120 (supported by a plurality of bearing assemblies 150). The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a shaft 120, a gas producer or compressor 200, a combustor 300, a turbine 400, an exhaust 500, and a power output coupling 130. The gas turbine engine 100 may have a single shaft or a dual shaft configuration.

The compressor 200 includes a compressor rotor assembly 210, compressor stationary vanes (“stators”) 250, and inlet guide vanes 255. The compressor rotor assembly 210 mechanically couples to shaft 120. As illustrated, the compressor rotor assembly 210 is an axial flow rotor assembly. The compressor rotor assembly 210 includes one or more compressor disk assemblies 220. Each compressor disk assembly 220 includes a compressor rotor disk that is circumferentially populated with compressor rotor blades. Stators 250 axially follow each of the compressor disk assemblies 220. Each compressor disk assembly 220 paired with the adjacent stators 250 that follow the compressor disk assembly 220 is considered a compressor stage. Compressor 200 includes multiple compressor stages. Inlet guide vanes 255 axially precede the first compressor stage.

The combustor 300 includes one or more injectors 310 and a combustion chamber 320.

The turbine 400 includes a turbine rotor assembly 410 and turbine nozzles 450. The turbine rotor assembly 410 mechanically couples to the shaft 120. As illustrated, the turbine rotor assembly 410 is an axial flow rotor assembly. The turbine rotor assembly 410 includes one or more turbine disk assemblies 420. Each turbine disk assembly 420 includes a turbine disk that is circumferentially populated with turbine blades. A turbine nozzle 450, such as a nozzle ring, axially precedes each of the turbine disk assemblies 420. Each turbine nozzle 450 includes multiple nozzle segments 451 grouped together to form a ring. Each turbine disk assembly 420 paired with the adjacent turbine nozzle 450 that precede the turbine disk assembly 420 is considered a turbine stage. Turbine 400 includes multiple turbine stages.

The turbine 400 may also include a turbine housing 430 and turbine diaphragms 440. Turbine housing 430 may be located radially outward from turbine rotor assembly 410 and turbine nozzles 450. Turbine housing 430 may include one or more cylindrical shapes. Each nozzle segment 451 may be configured to attach, couple to, or hang from turbine housing 430. Each turbine diaphragm 440 may axially precede each turbine disk assembly 420 and may be adjacent a turbine disk. Each turbine diaphragm 440 may also be located radially inward from a turbine nozzle 450. Each nozzle segment 451 may also be configured to attach or couple to a turbine diaphragm 440.

The exhaust 500 includes an exhaust diffuser 510 and an exhaust collector 520.

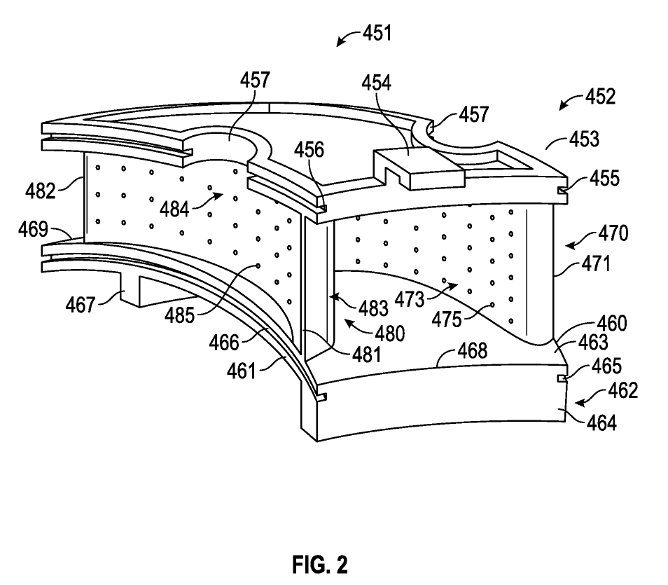

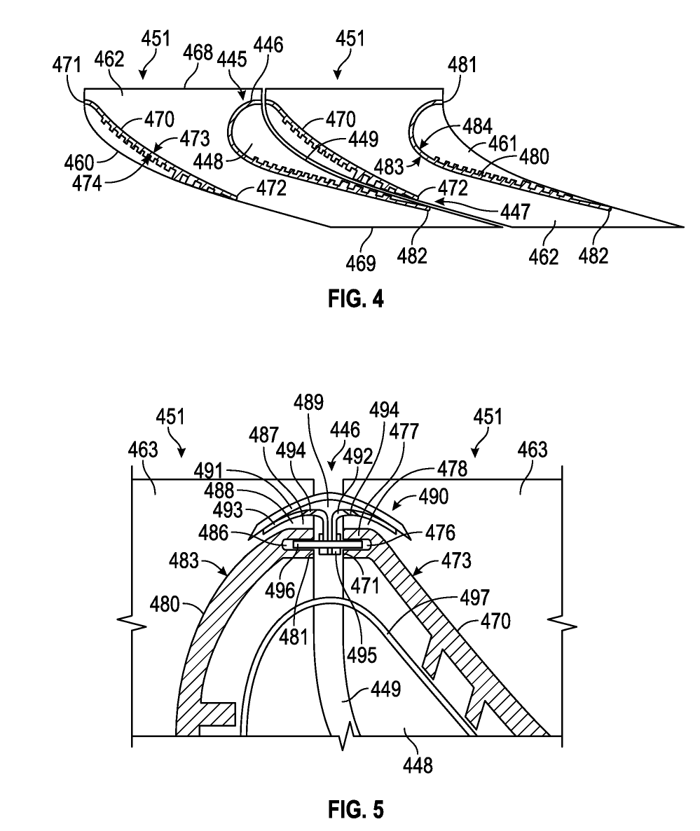

FIG. 2 is a perspective view of a nozzle segment 451 for the gas turbine engine 100 of FIG. 1. Nozzle segment 451 includes upper shroud 452, lower shroud 462, a pressure portion 470, and a suction portion 480. The pressure portion 470 and suction portion 480 of adjacent nozzle segments 451 are configured to form an airfoil 445 when installed in the gas turbine engine 100 (refer to FIG. 4). Nozzle segment 451 generally includes an upstream end 468, a downstream end 469 offset from the upstream end 468, a first side 460 extending from the upstream end 468 to the downstream end 469, and a second side 461 circumferentially offset from the first side 460 and also extending from the upstream end 468 to the downstream end 469.

Upper shroud 452 may be located adjacent and radially inward from turbine housing 430 when nozzle segment 451 is installed in gas turbine engine 100. Upper shroud 452 includes upper endwall 453. Upper endwall 453 generally extends axially from upstream end 468 to downstream end 469 and circumferentially from first side 460 to second side 461.

Upper endwall 453 includes a first arcuate shape and may be a portion of an annular shape. For example, the portion may be a portion of a toroid or of a hollow cylinder. Multiple upper endwalls 453 are arranged to form the annular shape, such as a toroid or a hollow cylinder, and to define the radially outer surface of the flow path through a turbine nozzle 450. Upper endwall 453 may be coaxial to center axis 95 when installed in the gas turbine engine 100.

Upper shroud 452 also includes an upper slashface 455 on each side of upper endwall 453. Each upper slashface 455 may generally follow the same curved contour and may extend in the axial and the circumferential directions. Each upper slashface 455 may generally be configured to be located circumferentially between a pressure portion 470 and a suction portion 480 that form an airfoil.

Upper shroud 452 may also include upper slashface groove 456 in each upper slashface 455. The upper slashface groove 456 may extend from upstream end 468 to downstream end 469. The upper slashface grooves 456 are configured to receive a slashface seal to prevent the ingress/egress of air through an upper slashface gap between adjacent upper slashfaces 455.

Upper shroud 452 may further include an upper inlet portion 457 located adjacent one or both upper slashfaces 455. The upper inlet portions 457 are configured to provide an ingress path for cooling air into the airfoil. In the embodiment illustrated in FIG. 2, each upper inlet portion 457 forms half of an ingress hole for cooling air. In other embodiments, the upper inlet portions 457 may be different sizes. In still other embodiments, only one side includes an upper inlet portion 457 that forms the entire ingress hole for cooling air.

Upper shroud 452 may also include upper forward rail 454. Upper forward rail 454 extends radially outward from upper endwall 453. In the embodiment illustrated in FIG. 2, upper forward rail 454 extends from upper endwall 453 at upstream end 468. Upper forward rail 454 may include a lip, protrusion or other features that may be used to secure nozzle segment 451 to turbine housing 430.

Lower shroud 462 is located radially inward from upper shroud 452. Lower shroud 462 may also be located adjacent and radially outward from turbine diaphragm 440 when nozzle segment 451 is installed in gas turbine engine 100. Lower shroud 462 includes lower endwall 463. Lower endwall 463 generally extends axially from upstream end 468 to downstream end 469 and circumferentially from first side 460 to second side 461.

Lower endwall 463 includes a second arcuate shape and may be a portion of an annular shape. For example, the portion may be a portion of a toroid or of a hollow cylinder. Multiple lower endwalls 463 are arranged to form the annular shape, such as a toroid or a hollow cylinder, and to define the radially inner surface of the flow path through a turbine nozzle 450. Lower endwall 463 may be coaxial to center axis 95 when installed in the gas turbine engine 100. Lower endwall 463 may include the same general shape as upper endwall 453.

Lower shroud 462 also includes a lower slashface 465 on each side of lower endwall 463. Each lower slashface 465 may generally follow the same curved contour and may extend in the axial and the circumferential directions. Each lower slashface 465 may generally be configured to be located circumferentially between a pressure portion 470 and a suction portion 480 that form an airfoil.

Lower shroud 462 may also include lower slashface groove 466 in each lower slashface 465. The lower slashface groove 466 may extend from upstream end 468 to downstream end 469. The lower slashface grooves 466 are configured to receive a slashface seal to prevent the ingress/egress of air through a slashface gap 449 (refer to FIG. 4) between adjacent lower slashfaces 465.

Lower shroud 462 may also include lower forward rail 464 and lower aft rail 467. Lower forward rail 464 extends radially inward from lower endwall 463. In the embodiment illustrated in FIG. 2, lower forward rail 464 extends from lower endwall 463 at an axial end of lower endwall 463. In other embodiments, lower forward rail 464 extends from lower endwall 463 near an axial end of lower endwall 463 and may be adjacent lower endwall 463 near the axial end of lower endwall 463. Lower forward rail 464 may include a lip, protrusion or other features that may be used to secure nozzle segment 451 to turbine diaphragm 440.

Lower aft rail 467 may also extend radially inward from lower endwall 463. In the embodiment illustrated in FIG. 2, lower aft rail 467 extends from lower endwall 463 near the axial end of lower endwall 463 opposite the location of lower forward rail 464 and may be adjacent the axial end of lower endwall 463 opposite the location of lower forward rail 464. In other embodiments, lower aft rail 467 extends from the axial end of lower endwall 463 opposite the location of lower forward rail 464. Lower aft rail 467 may also include a lip, protrusion or other features that may be used to secure nozzle segment 451 to turbine diaphragm 440.

Pressure portion 470 extends from upper endwall 453 to lower endwall 463. Pressure portion 470 is located adjacent, such as at or near, the first side 460 of upper endwall 453 and lower endwall 463. Pressure portion 470 includes a pressure portion surface 473. The pressure portion surface 473 forms at least a portion of the pressure side surface of an airfoil, such as all of the pressure side surface of the airfoil or a majority of the pressure side surface of the airfoil. The pressure portion surface 473 may include a concave shape. The pressure portion surface 473 may generally face towards the second side 461 and towards the suction portion 480. Pressure portion 470 may also include pressure side cooling features 475, such as cooling holes. Pressure side cooling features 475 may be configured to provide cooling air to the pressure side surface. The pressure portion 470 forms a first part of an airfoil 445 when installed in the turbine nozzle 450 (refer to FIG. 4).

Suction portion 480 extends from upper endwall 453 to lower endwall 463. Suction portion 480 is located adjacent, such as at or near, the second side 461 of upper endwall 453 and lower endwall 463. Suction portion 480 includes a suction portion surface 483. The suction portion surface 483 forms at least a portion of the suction side surface of an airfoil, such as all of the suction side surface of the airfoil or a majority of the suction side surface of the airfoil. The suction portion surface 483 may include a convex shape. The suction portion surface 483 may generally face towards the first side 461 and towards the pressure portion 470. Suction portion 480 may also include suction side cooling features 485, such as cooling holes. Suction side cooling features 485 may be configured to provide cooling air to the suction side surface. The suction portion 480 forms a second part of a different airfoil 445 than that of pressure portion 470 when installed in the turbine nozzle 450. The pressure portion 470 and suction portion 480 of adjacent nozzle segments 451 form an airfoil 445 when installed in the turbine nozzle (refer to FIG. 4).

A predetermined number of nozzle segments 451 are assembled together to form a turbine nozzle 450. The turbine nozzle 450 is a ring that includes the same number of airfoils 445 as nozzle segments 451, with each airfoil being formed by the pressure portion 470 and suction portion 480 of adjacent nozzle segments 451.

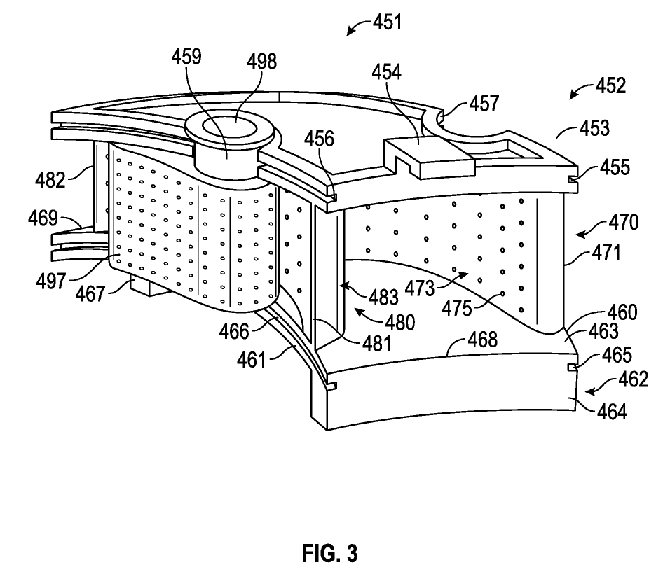

FIG. 3 is a perspective view of a nozzle segment 451 of FIG. 1 with a cooling insert 497. The turbine nozzle 450 may include cooling inserts 497. Each cooling insert 497 may be located between adjacent nozzle segments 451. The cooling insert 497 may include a cooling ingress extension 498 that is configured to extend beyond the upper endwalls 453 of the nozzle segments 451. In the embodiment illustrated, the cooling ingress extension 498 includes a neck 459 that is narrower than the remainder of the cooling ingress extension 498 and is configured to fit within the inlet path formed by one or more upper inlet portions 457 of the adjacent nozzle segments 451. The cooling air used to cool airfoil 445 may be supplied to the cooling ingress extension 498 and through the neck 459 to the cooling insert 497. Cooling insert 497 may then be used to direct and regulate the cooling air supply to various parts of the airfoil 445.

FIG. 4 is a cross-sectional view of two adjacent nozzle segments 451 for the gas turbine engine of FIG. 1. As illustrated in FIG. 4, the adjacent nozzle segments 451 may be slightly spaced apart forming a slashface gap 449 between adjacent upper slashfaces 455 and adjacent lower slashfaces 465. The slashface gaps 449 between the upper slashfaces 455 and the lower slashfaces 465 may extend at least partially in an axial and circumferential direction relative to an axis of the nozzle segments 562.

The pressure portion 470 of a first nozzle segment 451 and the suction portion 480 of an adjacent nozzle segment 451 form an airfoil 445. The pressure portion 470 and the suction portion 480 that form the airfoil 445 are located on opposite sides of the slashface gaps 449 and may form an airfoil cavity 448 there between. The slashface gaps 449 may at least partially curve along the mean camber line of the airfoil 445. The airfoil cavity 448 may be configured to provide cooling air to the airfoil 445.

Pressure portion 470 includes a pressure portion upstream end 471 proximate upstream end 468, such as adjacent upstream end 468 or closer to upstream end 468 than downstream end 469, and a pressure portion downstream end 472 proximate downstream end 469, such as adjacent downstream end 469 or closer to downstream end 469 than upstream end 468. Pressure portion surface 473 extends from pressure portion upstream end 471 to pressure portion downstream end 472.

Suction portion 480 includes a suction portion upstream end 481 proximate upstream end 468, such as adjacent upstream end 468 or closer to upstream end 468 than downstream end 469, and a suction portion downstream end 482 proximate downstream end 469, such as adjacent downstream end 469 or closer to downstream end 469 than upstream end 468. Suction portion upstream end 481 may also be adjacent pressure portion upstream end 471, and suction portion downstream end 482 may also be adjacent pressure portion downstream end 472. As illustrated, suction portion downstream end 482 may extend further than pressure portion downstream end 472 and may be closer to downstream end 469 than pressure portion downstream end 472. Suction portion surface 483 extends from suction portion upstream end 481 to suction portion downstream end 482.

In the embodiment illustrated, airfoil 445 is split at the leading edge 446 and at the trailing edge 447 with both the pressure portion 470 and the suction portion 480 extending from the leading edge 446 to the trailing edge 447. In other embodiments, the airfoil 445 may be split in other locations. In the embodiment illustrated, the pressure portion upstream end 471 of a first nozzle segment 451 and the suction portion upstream end 481 of a second nozzle segment 451 are aligned in the axial direction and offset in the circumferential direction such that there is a circumferential gap there between. In the embodiment illustrated, the pressure portion 470 of a given nozzle segment 451 forms a first segment of a first leading edge 446 of a first airfoil 445, while the suction portion 480 of the given nozzle segment 451 forms a second segment of a second leading edge 446 of a second airfoil 445.

Pressure portion 470 may also include a pressure cavity surface 474. Pressure cavity surface 474 may be opposite pressure portion surface 473 and forms a first portion of a first airfoil cavity 448. Pressure cavity surface 474 may face circumferentially outward and generally away from suction portion 480 of the same nozzle segment 451, while generally facing towards the suction portion 480 of an adjacent nozzle segment 451.

Suction portion 480 may also include a suction cavity surface 484. Suction cavity surface 484 may be opposite suction portion surface 483 and forms a second portion of a second airfoil cavity 448 (the first portion of the second airfoil cavity 448 being formed by a pressure cavity surface 474 of an adjacent nozzle segment 451 and the second portion of the first airfoil cavity 448 being formed by a suction cavity surface 484 of another adjacent nozzle segment 451). Suction portion surface 483 may face circumferentially outward relative to the nozzle segment 451 and may generally face away from pressure portion 470 of the same nozzle segment 451, while generally facing towards the pressure portion 470 of an adjacent nozzle segment 451. Pressure cavity surface 474 and suction cavity surface 484 of adjacent nozzle segments 451 may form the outer boundary of an airfoil cavity 448.

FIG. 5 is a cross-sectional view of a portion of adjacent nozzle segments 451 illustrating an alternate embodiment of the leading edge 446 of the airfoil 445 formed by the adjacent nozzle segments 451 of FIG. 4. As illustrated in FIG. 5, the leading edge 446 of each airfoil 445 may be formed with a grommet 490. Pressure portion 470 may include a pressure side grommet receiving portion 477 at pressure portion upstream end 471, and suction portion 480 may include a suction side grommet receiving portion 487 at suction portion upstream end 481. Pressure side grommet receiving portion 477 and suction side grommet receiving portion 487 may generally extend in the circumferential direction relative to the axis of the upper endwall 453 and the lower endwall 463.

Pressure side grommet receiving portion 477 includes one or more pressure side receiving features 476, and suction side grommet receiving portion 487 includes one or more suction side receiving features 486. Pressure side receiving features 476 and suction side receiving features 486 are features, such as slots or blind holes, configured to retain grommet 490 in place. For a given nozzle segment 451, the pressure side grommet receiving feature 477 is configured to retain a first grommet 490, such as a portion of the first grommet 490 and the suction side grommet receiving feature 487 is configured to retain a second grommet 490, such as a portion of the second grommet 490.

Grommet 490 may extend from upper endwall 453 to lower endwall 463. Grommet 490 may include a grommet leading edge 491, a grommet body 495, and one or more connection arms, such as one or more grommet first arms 492 and one or more grommet second arms 493. Grommet leading edge 491 may extend from upper endwall 453 to lower endwall 463. Grommet leading edge 491 may generally have a curved shape, such as a hyperbolic cylinder. The cross-section of grommet leading edge 491 may be a conic section, such as a hyperbola. A thermal barrier coating may be applied to all or a portion of grommet 490, such as the grommet leading edge 491.

Grommet leading edge 491 may be spaced apart from and upstream of both the pressure portion 470 and the suction portion 480. Grommet leading edge 491 may overlap with pressure portion 470 at pressure portion upstream end 471 and may form a pressure side film jet 478. Pressure side film jet 478 may be configured to direct cooling air along pressure portion surface 473. Grommet leading edge 491 may also overlap with suction portion 480 at suction portion upstream end 481 and may form a suction side film jet 488. Suction side film jet 488 may be configured to direct cooling air along suction portion surface 483.

Grommet body 495 may be a rod, such as a cuboid extending between upper endwall 453 and lower endwall 463. Grommet body 495 may be located between pressure portion upstream end 471 and suction portion upstream end 481. Grommet body 495 includes one or more grommet anchors 496. Grommet anchors 496 are configured to extend into pressure side grommet receiving portion 477 and into suction side grommet receiving portion 487. In embodiments, grommet anchors 496 are rods, such as cuboids or cylinders. In other embodiments, a single grommet anchor 496 may be used, such as a plate extending between upper endwall 453 and lower endwall 463, and extending into pressure side grommet receiving portion 477 and into suction side grommet receiving portion 487. In some embodiments, grommet body 495 is a single plate forming the grommet anchor 496.

Connection arms join grommet leading edge 491 to grommet body 495. In the embodiment illustrated, grommet first arm 492 extends from grommet body 495 in the axial direction relative to the axis of the upper endwall 453 and the lower endwall 463 and curves towards the pressure portion 470. Grommet first arm 492 connects to grommet body 495 at one end and connects to grommet leading edge 491 at or near the other end. Grommet second arm 493 is adjacent grommet first arm 492. Grommet second arm 493 extends from grommet body 495 in the axial direction and curves towards suction portion 480. Grommet second arm 493 connects to grommet body 495 at one end and connects to grommet leading edge 491 at or near the other end. In embodiments, grommet first arm 492 and grommet second arm 493 are elongated plates that extend in the profile described above. In other embodiments, a plurality of grommet first arms 492 and a plurality of grommet second arms 493 are used, with each of the arms being a rod curved in the profile described above.

Grommet first arm 492, grommet second arm 493 and grommet leading edge 491 may be configured to form a cooling channel 489 there between. Grommet first arm 492 and grommet second arm 493 may each include one or more grommet cooling holes 494. Grommet cooling holes 494 connect cooling channel 489 to pressure side film jet 478 and suction side film jet 488. A first grommet cooling hole 494 or set of holes may fluidly connect the cooling channel 489 to the pressure side film jet 478 and a second grommet cooling hole 494 or set of holes may fluidly connect the cooling channel 489 to the suction side film jet 488. Cooling air may be directed from airfoil cavity 448 through grommet body 495 and between grommet first arm 492 and grommet second arm 493. The cooling air may then be directed from cooling channel 489 through the grommet cooling holes 494 and into both pressure side film jet 478 and suction side film jet 488.

The various components of grommet 490 may be formed from a single sheet of metal or may be joined by a metallurgical bond, such as a weld or braze. In some embodiments, the grommet leading edge 491, the grommet first arm 492 and the grommet second arm 493 are formed from a single sheet of metal while the other portions of the grommet 490 are joined by a metallurgical bond.

As illustrated in FIG. 5, the cooling insert 497 may be inserted within the airfoil 445 between the pressure portion 470 and the suction portion 480.

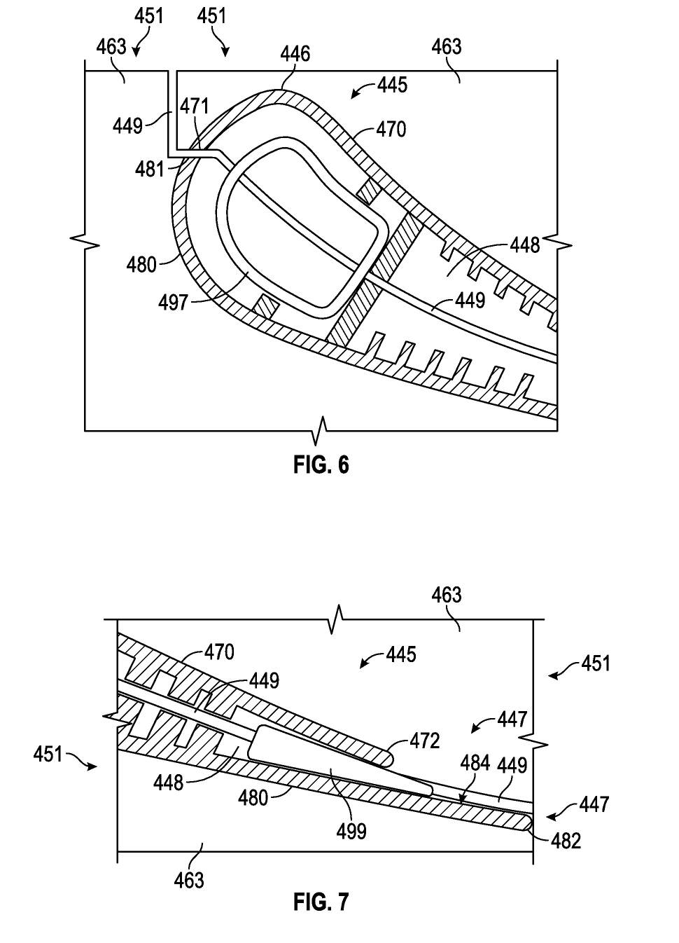

FIG. 6 is a cross-sectional view of a portion of adjacent nozzle segments 451 illustrating another alternate embodiment of the leading edge 446 of the airfoil 445 formed by the adjacent nozzle segments 451 of FIG. 4. As illustrated in FIG. 6, the airfoil 445 may be split at locations other than the leading edge 446. In the embodiment illustrated, pressure portion 470 includes leading edge 446 and an upstream segment of the suction side of a first airfoil 445 with the pressure portion upstream end 471 being located at the suction side of the first airfoil 445 proximate the leading edge 446. Also in the embodiment illustrated, suction portion 480 forms a downstream segment of a second suction side of a second airfoil 445 and includes a portion of the trailing edge 447. In this embodiment, suction portion upstream end 481 is located in the suction side of the airfoil 445.

Pressure portion upstream end 471 may be configured to face in the aft direction, while suction portion upstream end 481 may be configured to face in the forward direction. The slashface gap 449 and split of airfoil 445 between pressure portion upstream end 471 and suction portion upstream end 481 may extend in the circumferential direction relative to the axis of upper endwall 453 and lower endwall 463. In the embodiment illustrated, pressure portion upstream end 471 and suction portion upstream end 481 are circumferentially aligned and axially offset so as to form an axial gap there between.

FIG. 7 is a cross-sectional view of a portion of adjacent nozzle segments 451 illustrating an alternate embodiment of the trailing edge of the airfoil 445 formed by the adjacent nozzle segments 451 of FIG. 4. In the embodiment illustrated, airfoil 445 includes a trailing edge insert 499. Trailing edge insert 499 may include a wedge shape. Trailing edge insert 499 is configured to direct and meter cooling air to exit airfoil 445 at trailing edge 447. Trailing edge insert 499 may also include air passages, such as axial grooves, to route cooling air in a controlled manner. A portion of trailing edge insert 499 may be configured to extend beyond pressure portion downstream end 472. Trailing edge insert 499 may be configured to direct cooling air along a portion of suction cavity surface 484 that extends beyond pressure portion downstream end 472 and is adjacent suction portion downstream end 482.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

### INDUSTRIAL APPLICABILITY

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries.

Referring to FIG. 1, a gas (typically air 10) enters the inlet 110 as a “working fluid”, and is compressed by the compressor 200. In the compressor 200, the working fluid is compressed in an annular flow path 115 by the series of compressor disk assemblies 220. In particular, the air 10 is compressed in numbered “stages”, the stages being associated with each compressor disk assembly 220. For example, “4th stage air” may be associated with the 4th compressor disk assembly 220 in the downstream or “aft” direction, going from the inlet 110 towards the exhaust 500). Likewise, each turbine disk assembly 420 may be associated with a numbered stage.

Once compressed air 10 leaves the compressor 200, it enters the combustor 300, where it is diffused and fuel is added. Air 10 and fuel are injected into the combustion chamber 320 via injector 310 and combusted. Energy is extracted from the combustion reaction via the turbine 400 by each stage of the series of turbine disk assemblies 420. Exhaust gas 90 may then be diffused in exhaust diffuser 510, collected and redirected. Exhaust gas 90 exits the system via an exhaust collector 520 and may be further processed (e.g., to reduce harmful emissions, and/or to recover heat from the exhaust gas 90).

Operating efficiency of a gas turbine engine generally increases with a higher combustion temperature. Thus, there is a trend in gas turbine engines to increase the combustion temperatures. Gas reaching forward stages of a turbine from a combustion chamber 320 may be 1000 degrees Fahrenheit or more. To operate at such high temperatures a portion of the compressed air 10 from the compressor 200, cooling air, may be diverted through internal passages or chambers to cool various components of a turbine including nozzle segments such as nozzle segment 451.

Nozzle segments 451 include a split airfoil 445. With a split airfoil 445 the airfoil cavity 448 is not formed until assembly of the turbine nozzle 450. Nozzle segments 451 may be manufactured without the limitations of forming a fully enclosed airfoil cavity, such as forming and airfoil around a cavity with a core-die. Core-dies may be expensive to produce, may be damaged or worn prior to use in the manufacturing process, and may only be used once. Manufacturing a nozzle segment 451 without a core-die may reduce manufacturing costs and complexity.

Size and shape constraints for inserts used in a fully enclosed airfoil cavity can be avoided by inserting cooling inserts 497 and trailing edge inserts 499 between a pressure portion 470 and a suction portion 480 during assembly of turbine nozzle 450. This may allow for the use of more complex internal cooling features for turbine nozzle 450 with split airfoils 445.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes a particular nozzle segment, it will be appreciated that the nozzle segment in accordance with this disclosure can be implemented in various other configurations, can be used with various other types of gas turbine engines, and can be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A nozzle segment for a turbine nozzle of a gas turbine engine, the nozzle segment comprising:
an upper endwall;
a lower endwall spaced apart from the upper endwall;
a pressure portion extending between the upper endwall and the lower endwall adjacent a first side of the nozzle segment, the pressure portion forming a first part of a first airfoil and including a pressure cavity surface configured to form a first portion of a first airfoil cavity, the pressure cavity surface facing circumferentially outward relative to the nozzle segment; and
a suction portion spaced apart from the pressure portion and extending between the upper endwall and the lower endwall adjacent a second side of the nozzle segment, the suction portion forming a second part of a second airfoil and including a suction cavity surface configured to form a second portion of a second airfoil cavity, the suction cavity surface facing circumferentially outward relative to the nozzle segment and away from the pressure portion;
wherein the second side is opposite the first side.

2. The nozzle segment of claim 1, wherein the pressure portion includes a pressure portion upstream end adjacent an upstream end of the nozzle segment and a pressure portion downstream end adjacent a downstream end of the nozzle segment, and wherein the suction portion includes a suction portion upstream end adjacent the upstream end and a suction portion downstream end adjacent the downstream end.

3. The nozzle segment of claim 2, wherein the pressure portion includes a pressure portion surface extending from the pressure portion upstream end to the pressure portion downstream end, the pressure portion surface including a concave shape, and wherein the suction portion includes a suction portion surface extending from the suction portion upstream end to the suction portion downstream end, the suction portion surface including a convex shape.

4. The nozzle segment of claim 1, wherein the pressure portion forms a pressure side of the first airfoil and the suction portion forms a suction side of the second airfoil.

5. The nozzle segment of claim 4, wherein the pressure portion forms a first segment of a first leading edge of the first airfoil and the suction portion forms a second segment of a second leading edge of the second airfoil.

6. The nozzle segment of claim 1, wherein the pressure portion forms a pressure side, a leading edge and an upstream segment of a first suction side of the first airfoil and the suction portion forms a downstream segment of a second suction side of the second airfoil and a trailing edge of the second airfoil.

7. The nozzle segment of claim 1, wherein the pressure portion includes a pressure side grommet receiving feature at the pressure portion upstream end, the pressure side grommet receiving feature being configured to retain a first grommet, and wherein the suction portion includes a suction side grommet receiving feature at the suction portion upstream end, the suction side grommet receiving feature being configured to retain a second grommet.

8. A turbine nozzle for a gas turbine engine, the turbine nozzle comprising:
a first nozzle segment including
a first upper endwall,
a first lower endwall,
a first pressure portion extending between the first upper endwall and the first lower endwall, and
a first suction portion extending between the first upper endwall and the first lower endwall; and
a second nozzle segment including
a second upper endwall circumferentially adjacent the first upper endwall,
a second lower endwall circumferentially adjacent the first lower endwall,
a second pressure portion extending between the first upper endwall and the first lower endwall, and
a second suction portion extending between the second upper endwall and the second lower endwall, the second suction portion and the first pressure portion forming an airfoil.

9. The turbine nozzle of claim 8, wherein the first pressure portion includes a pressure portion upstream end and the second suction portion includes a suction portion upstream end that is adjacent the pressure portion upstream end.

10. The turbine nozzle of claim 9, wherein the pressure portion upstream end and the suction portion upstream end form a leading edge of the airfoil.

11. The turbine nozzle of claim 9, wherein the pressure portion includes a leading edge of the airfoil, and wherein the pressure portion upstream end and the suction portion upstream end are circumferentially aligned and axially offset.

12. The turbine nozzle of claim 9, wherein the pressure portion upstream end includes a pressure side grommet receiving feature and the suction portion upstream end includes a suction side grommet receiving feature, and the turbine nozzle further comprises a grommet that forms a leading edge of the airfoil, the grommet being retained by the pressure side grommet receiving feature and the suction side grommet receiving feature.

13. The turbine nozzle of claim 12, wherein the grommet includes a grommet leading edge located adjacent the pressure portion upstream end and the suction portion upstream end, a grommet body including a grommet anchor extending into the pressure side grommet receiving feature and the suction side grommet receiving feature, and a grommet first arm connecting the grommet leading edge to the grommet body.

14. The turbine nozzle of claim 13, wherein the grommet further includes a grommet second arm connecting the grommet body to the grommet leading edge.

15. The turbine nozzle of claim 14, wherein the grommet first arm, the grommet second arm, and the grommet leading edge are configured to form a cooling channel, wherein the grommet leading edge is spaced apart from the pressure portion upstream end forming a pressure side film jet there between and the grommet leading edge is spaced apart from the suction portion upstream end forming a suction side film jet there between, and wherein the grommet first arm includes a first grommet cooling hole that fluidly connects the cooling channel to the pressure side film jet and the grommet second arm includes a second grommet cooling hole that fluidly connects the cooling channel to the suction side film jet.

16. The turbine nozzle of claim 8, further comprising a cooling insert, wherein the first pressure portion and the second suction portion form an airfoil cavity there between and at least a portion of the cooling insert is located within the airfoil cavity.

17. The turbine nozzle of claim 8, wherein the first upper endwall and the second upper endwall form an upper slashface gap there between, and the first lower endwall and the second lower endwall form a lower slashface gap there between, wherein the upper slashface gap and the lower slashface gap extend at least partially in an axial and in a circumferential direction relative to an axis of the first nozzle segment and the second nozzle segment, the upper slashface gap and the lower slashface gap curving at least partially along a mean camber line of the airfoil.

18. The turbine nozzle of claim 8, wherein the second suction portion includes a second suction portion downstream end and the first pressure portion includes a first pressure portion downstream end, the second suction portion downstream end and the first pressure portion downstream end forming a trailing edge, and the turbine nozzle further comprising a trailing edge insert located between the pressure portion and the suction portion adjacent the suction portion downstream end, the trailing edge insert being configured to direct cooling air to exit the airfoil at the trailing edge.

19. A nozzle segment for a turbine nozzle of a gas turbine engine, the nozzle segment comprising:
an upper endwall including a first arcuate shape;
a lower endwall located inward from the upper endwall, the lower endwall including a second arcuate shape;
a pressure portion extending between the upper endwall and the lower endwall adjacent a first side of the nozzle segment, the pressure portion being configured to form a first portion of a first airfoil; and
a suction portion circumferentially spaced apart from the pressure portion and extending between the upper endwall and the lower endwall adjacent a second side of the nozzle segment, the second side being opposite the first side, the suction portion being configured to form a second portion of a second airfoil.

20. The nozzle segment of claim 19, wherein the pressure portion includes a pressure portion upstream end adjacent an upstream end of the nozzle segment and a pressure portion downstream end adjacent a downstream end of the nozzle segment, wherein the suction portion includes a suction portion upstream end adjacent the upstream end and a suction portion downstream end adjacent the downstream end, and wherein the pressure portion upstream end is configured to form at least a portion of a leading edge of the first airfoil and the suction portion downstream end is configured to form a trailing edge of the second airfoil.
